(19) United States
(12) Patent Application Publication
(10) Pub. No.: US 2024/0399914 A1
(43) Pub. Date: Dec. 5, 2024

(54) RAIL VEHICLE, CHARGING STATION, METHOD FOR CHARGING A RAIL VEHICLE AND CHARGING SYSTEM

(71) Applicant: Stadler Rail AG, Bussnang (CH)

(72) Inventor: Jorgen TSCHENG, Zürich (CH)

(73) Assignee: Stadler Rail AG, Bussnang (CH)

(21) Appl. No.: 18/679,997

(22) Filed: May 31, 2024

(30) Foreign Application Priority Data
Jun. 2, 2023 (EP) 23176900.1

(51) Int. Cl. B60L 53/62; B60L 53/14; B60L 53/30; B60L 53/53

(52) U.S. Cl. CPC B60L 53/62; B60L 53/14; B60L 53/305; B60L 53/53

(57) ABSTRACT

A rail vehicle is disclosed which comprises an electrical energy storage device (2), a charging contact device (7), a charging controller and a DC link (1). The electrical energy storage device (2) and the charging contact device (7) are each connected to the DC link 1. A charging switch (8) is arranged between the charging contact device (7) and the DC link (1). The charging switch (8) is controlled by the charging control via a component of the hardware circuit (9) in such a way that the charging switch (8) can only be closed at a switch-on voltage level and an electrical connection between the charging contact device (7) and the DC link (1) can be achieved, the component of the charging control being in particular a hardware circuit (9).

### FIELD OF THE INVENTION

The invention relates to a rail vehicle, a charging station, a method for charging a rail vehicle and a charging system.

### BACKGROUND OF THE INVENTION

It is known to charge traction batteries of rail vehicles using charging stations. For this purpose, an electrically conductive connection must be established between the vehicle and the charging station. It must be ensured that there are no impermissible operating states, in particular no impermissible voltage or current peaks, on either the vehicle or the charging station side. Furthermore, the safety of persons present must be guaranteed. A method for establishing contact between the vehicle and the charging station is known from EP 3 597 469. However, this method is complex and not suitable for vehicles in which the traction batteries do not have associated power converters.

### SUMMARY OF THE INVENTION

It is therefore the object of the present invention to create a rail vehicle, a charging station, a method for charging a rail vehicle and a charging system which avoids the disadvantages of the prior art and, in particular, enables contact between the vehicle and the charging station in a safe manner.

The problem is solved by a rail vehicle, a charging station, a method for charging a rail vehicle and a charging system according to the independent claims.

In particular, the problem is solved by a rail vehicle comprising an electrical energy storage device, a charging contact device, a charging controller and a DC link. The electrical energy storage device and the charging contact device are each connected to the DC link. A charging switch is arranged between the charging contact device and the DC link. The charging switch is controlled by a charging control component in such a way that the charging switch can only be closed at a switch-on voltage level and an electrical connection can be established between the charging contact device and the DC link. The charging control component can be a hardware circuit.

Controlling the charging switch via the charging control component ensures that the charging contact device is not energised unintentionally. The hardware circuit can be designed as a relay circuit without electronics. The hardware circuit can be structurally separated from the general charging control system, which can also include sensitive sensors and control software. This makes the rail vehicle robust and durable. The hardware circuit can be designed and electromechanically dimensioned so that it does not close if the voltage is too low or too high. The hardware circuit mechanically separates two electrical conductors so that an insulating medium is arranged between the two electrical conductors when the hardware circuit is open and no current can flow between the conductors. When the hardware circuit is closed, the two conductors are electrically connected by a conductive medium and the electric current can flow between the two conductors. The energy storage device is preferably a battery.

The switch-on voltage level is below the battery voltage level of the rail vehicle. This allows the rail vehicle to recognise when a connection to the charging station has been established. It is possible for the rail vehicle to recognise whether another rail vehicle is already connected to the charging station and/or the charging station is already in charging mode. Only when the switch-on voltage is supplied the hardware switch on the vehicle is closed and an electrical connection between the charging station and the rail vehicle is enabled. The hardware circuit is preferably a relay circuit. The hardware circuit can also be designed as a voltage divider. It is possible that the hardware circuit comprises a relay circuit and a voltage divider.

With a rail vehicle of this type, an electrical connection between the rail vehicle and the charging device can be achieved easily and safely.

It is possible for the charging station to have a precharging device and/or a current limiting device. In this case, the current and voltage are transmitted electrically via the pre-charging device and/or the current limiting device. In this way, current peaks, for example when switching to the charging state, can be avoided.

The rail vehicle can include communication means for communicating with the charging station.

In this way, the rail vehicle can inform the charging station that charging should be terminated or that the charging voltage and/or the charging current should be adjusted during the charging process. It is possible that the communication means comprises wireless LAN, a remote diagnostic system, a PIS system (Passenger Information System) or a hardware interface. It is also possible for the communication means to comprise a combination of the aforementioned components.

This allows the charging process to be optimised.

The rail vehicle can comprise two charging contact devices.

This means that two contacts can be made with the charging device and a return current via the rail is not necessary.

The charging switch can only be closed via the charging controller.

This means that the charging switch is only closed when a switch-on voltage is detected by the charging controller. The charging switch is therefore not switched on directly by software, but only via the switch-on voltage applied. As this switch-on voltage is only present when the charging contact device is connected to the charging station, it is possible to prevent the charging contact device from being energised unintentionally when the charging contact device is not connected to the charging station or when the charging station is not in operation. This can prevent the charging contact device from being energised when no rail vehicle is to be charged and maintenance work is being carried out, for example.

It is possible that the charging station only provides electric current when a rail vehicle is connected to the charging contact device, the rail vehicle is detected and the charging controller receives the command to charge the rail vehicle, for example via the communication medium. The rail vehicle can be detected via a balise or an RFID tag, for example.

This guarantees that the charging process is switched on safely.

The charging contact device can be designed with two poles.

This means that a common reference potential is formed between the vehicle and the charging station and no return current needs to be routed via the rail. This is particularly advantageous for rails that are not designed for return current routing, such as diesel lines, as the track-side equipment is not designed for return current routing and can therefore be disrupted. It is possible for the rail vehicle to be charged via the charging contact device using direct current via a direct current circuit. In this case, the charge carriers (electrons) in the DC intermediate circuit always move in the same direction during the charging process.

The energy storage devices can be connected directly to the intermediate DC circuit, in particular without an additional energy storage device converter.

A charging station for charging a rail vehicle, in particular a rail vehicle as described above, is also used to solve the problem. The charging station comprises a charging station controller and a contact point for electrical connection to a charging contact device of a rail vehicle. The charging station controller is designed in such a way that a switch-on voltage can be applied to the contact point and the charging station recognises when a higher battery voltage of the rail vehicle is present than the switch-on voltage of the charging station and the voltage level of the charging station can then be increased to the charging voltage.

Such a charging station automatically recognises whether a rail vehicle is electrically connected to the charging station and can thus safely apply the charging voltage without the need for further communication with the rail vehicle.

This also ensures that no voltage is unintentionally applied to the charging contact device by the rail vehicle.

The battery voltage of the rail vehicle is higher than the switch-on voltage of the charging station. This ensures that no current can flow towards the battery during this phase. The charging switch of the rail vehicle remains closed.

The charging station can comprise a regulated rectifier and a power supply.

The power supply can be a power grid or a diesel generator. It is possible for the power supply to include fuel cells or batteries. The rectifier enables the charging station to adapt the voltage level to the current requirements. The rectifier can be a regulated rectifier.

A line contactor with precharging contactor, in particular an electronic contactor such as an IGBT, can be arranged between the contact point and the rectifier. Alternatively, a current limiting device can be arranged between the contact point and the rectifier. The precharging contactor can be designed as a current limiting device.

A charging station of this type enables a higher voltage to be applied if this is required for charging.

A method for charging a rail vehicle, in particular a rail vehicle as described above, with a charging station, in particular with a charging station as described above, also leads to the solution of the problem. The method comprises the following steps:
Applying a switch-on voltage level to the contact point of the charging station,
establishing an electrically conductive connection between the charging contact device and the contact point while the switch-on voltage level is applied,
Closing the charging switch so that the DC link of the rail vehicle is connected to the charging station, whereby the battery voltage level of the rail vehicle is present,
Recognising the applied battery voltage level by the charging station, whereby the battery voltage level is higher than the switch-on voltage level of the charging station,
increasing the voltage level by the charging station from the switch-on voltage level to a charging voltage level.

With such a method, the rail vehicle can easily determine whether there is an electrical connection to the charging station, and only when the rail vehicle releases the charging of the batteries can a higher voltage be applied at all. This makes the process safe and simple. The method also makes it possible to control and regulate the charging current. In this way, a charging process can be controlled and carried out in a particularly advantageous way.

The charging voltage is typically less than 1000 V

The switch-on voltage level can be applied to the contact point of the charging station via a current limiting device.

Such a procedure prevents current peaks.

Recognising the applied battery voltage level by the charging station ensures that a switch-on voltage level of the charging station can be selected which is below the battery voltage level. This is particularly relevant if the battery is not charged or only slightly charged.

The switch-on voltage can be in the range of 400 V. It is important here that the switch-on voltage is below the discharged battery voltage, for example below the lowest operationally permissible voltage of the compatible batteries of the rail vehicle. The battery voltage, which is also the intermediate circuit voltage, is typically in the range of 600 to 1000 V. The battery voltage can also be around 200 V. The switch-on voltage level is lower than the lower voltage range of the energy storage unit, in particular essentially in a range from 300 to 400 V.

As soon as the charging station recognises the higher voltage, i.e. the battery voltage, it increases its output voltage, closes the line contactor and disconnects the pre-charging or current limiting device. The switch-on voltage is applied via the pre-charging and/or current-limiting device before the pre-charging and/or current-limiting device is disconnected.

The charging station can detect the presence of a rail vehicle in advance.

This enables the switch-on voltage level to be switched on only when a rail vehicle is actually detected in the vicinity of the charging station, thus saving energy and increasing safety. The detection of a rail vehicle can be carried out by known means such as optical detection or electrical or electronic detection.

The rail vehicle can communicate with the charging station via the communication means, in particular by specifying a charging current or a charging voltage to the charging station.

Such communication is optional if either the charging currents are not fully utilised or predefined charging characteristics are specified. The safety functions of the batteries prevent unauthorised charging states.

Communication with the charging station enables optimum charging of the rail vehicle.

The charging process can be terminated by the vehicle, in particular by opening the charging switch and/or by interrupting the contact between the charging contact device and the contact point.

This means that the rail vehicle can also interrupt the charging process without communication means if necessary. If there is communication between the charging station and the rail vehicle, the charging station will first reduce the charging current, for example by adjusting it to the switch-on voltage. The vehicle can then disconnect from the contact point by opening the charging switch and removing the charging contact device from the contact point. The disconnection can take place without current.

Optimum disconnection of the charging connection with communication is therefore very possible, but this communication is not necessary. This means that the means of communication does not necessarily have to be fail-safe.

This means that the charging process can be carried out simply and cheaply at any time and is also easy to optimise.

The rail vehicle can therefore use the means of communication to inform the charging station that the charging process should be terminated before the charging switch is opened, whereby the charging station then lowers the voltage in particular and the charging station opens the line contactor.

This allows the charging process to be optimally terminated.

If the return current is to be conducted via the wheels and rails during charging, both the charging station and the intermediate circuit must be at earth potential with the negative pole of the battery. In this case, only a contact device and a switch are required. The voltage detection of the charging controller detects the voltage between the contact device and the earth potential on the wheel.

If a return current via the rail is to be avoided, two contact devices are required. The voltage detection of the charge controller then takes place between the two contact devices. In this case, the reference earth potential between the vehicle and the charging device must be matched in order to avoid equalising and common-mode currents.

If a vehicle has several battery circuits, only one charging station can be used. In this case, the most deeply discharged battery circuit is charged first and when the voltage reached corresponds to the next most highly charged battery circuit, this is switched on. This means that several charging stations are not necessary. It is possible for the rail vehicle to load (discharge) or charge the batteries essentially evenly.

The problem is further solved by a charging system which comprises a rail vehicle as described above and a charging station as described above, whereby a procedure as described above can be carried out.

Such a charging system enables simple, safe and reliable charging of a battery-operated rail vehicle.

### BRIEF DESCRIPTION OF THE DRAWINGS

The invention is explained in more detail below in embodiments with reference to figures. This shows:

FIG. 1: The traction chain of a rail vehicle,

FIG. 2: the traction chain from FIG. 1. with two current collectors,

FIG. 3: the charging station.

### DETAILED DESCRIPTION OF THE PREFERRED EMBODIMENTS

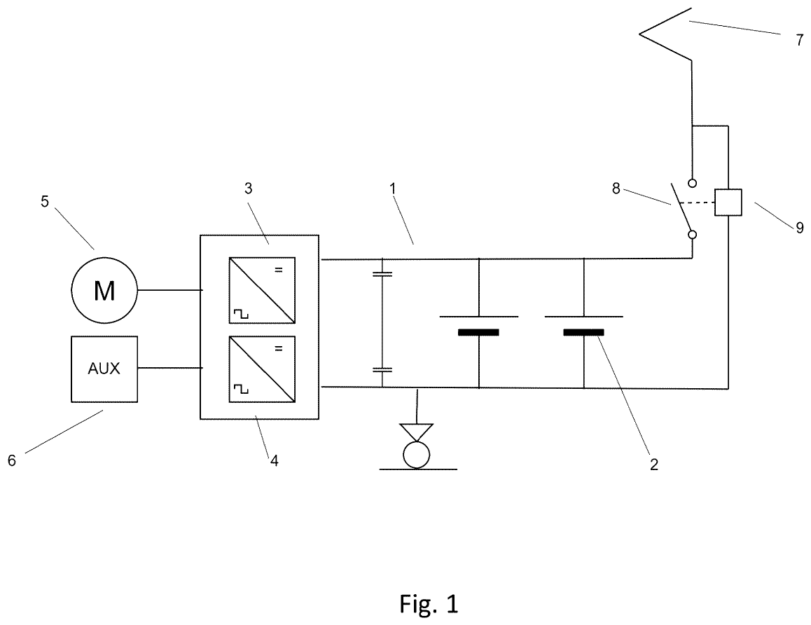

FIG. 1 shows the traction chain of a rail vehicle according to the invention. The rail vehicle comprises a DC link 1 that is directly connected to electrical energy storage devices 2. The DC link 1 is connected to the traction motors 5 via motor converters 3. The DC link 1 is also connected to auxiliary drives 6 via auxiliary drive converters 4. This means that the DC link 1 can supply motors and auxiliaries with energy. The DC link 1 is also connected to the charging contact device 7 via charging switch 8. The energy storage devices 2 can be charged with electrical energy via the charging contact device 7. The charging switch 8 is also controlled via the hardware circuit 9 in such a way that the charging switch 8 can only be closed at a switch-on voltage level and an electrical connection between the charging contact device 7 in the DC link 1 can be achieved. The hardware circuit 9 is preferably a relay circuit. The charging contact device 7 can be brought into contact with a charging station via a contact point 25 (not shown) and thus be charged via the charging station.

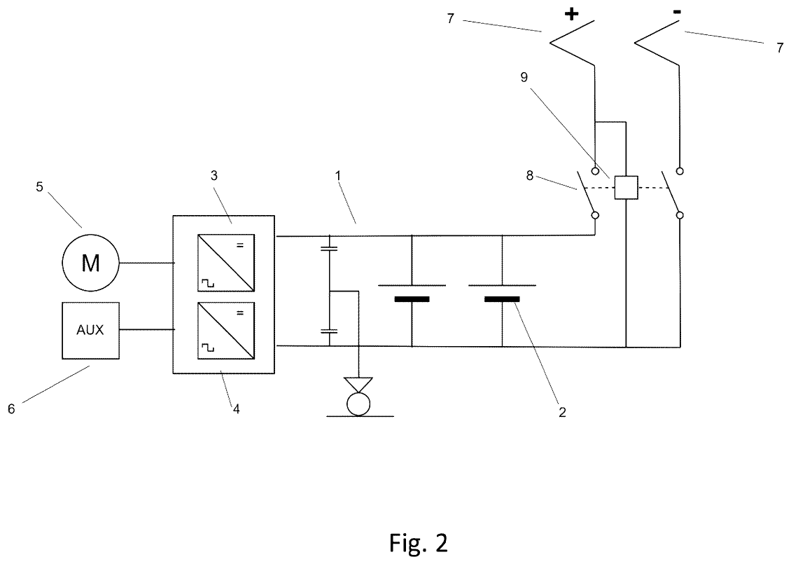

FIG. 2 shows the traction chain analogue to FIG. 1 with two charging contact devices 7, meaning that there are also two charging switches 8, one charging switch 8 per charging contact device 7. The hardware circuit 9 also corresponds to the hardware circuit 9 in FIG. 1 and ensures that both charging switches 8 can only be closed when the switch-on voltage is applied. All other components in FIG. 2 correspond to the illustration in FIG. 1. In both figures, the switch-on voltage level, which causes the charging switches 8 to be closable, is below the battery voltage level of the rail vehicle.

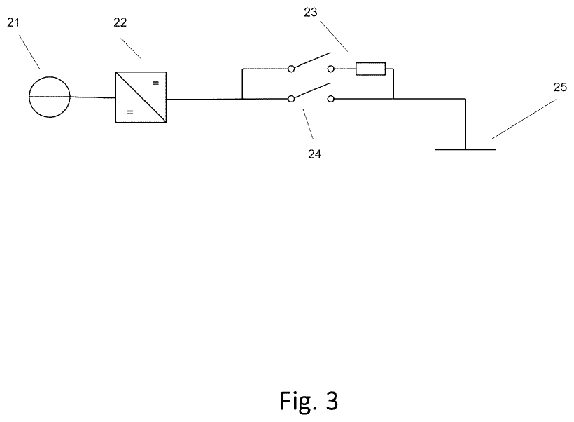

FIG. 3 shows the charging station according to the invention. The charging station comprises a DC voltage source 21 that is connected to a rectifier 22, which converts a direct current to another direct current. The rectifier is then a DC/DC converter. The rectifier 22 is connected to the contact point 25 of the charging station via linear contactor 24 with precharging contactor 23 or current limiting device 23. The contact point 25 is designed to be electrically connected to a charging contact device 7 of a rail vehicle as shown in FIGS. 1 and 2. The DC voltage source 21 can of course be supplied by any type of power supply. When a rail vehicle is deactivated in the charging station, the charging station applies a switch-on voltage level to the contact point 25 of the charging station. As soon as an electrically conductive connection is established between the charging contact device 7 of the rail vehicle and the contact point 25 during the switch-on voltage level, the switches on the vehicle (not shown) are closed and the charging station then detects the presence of a battery voltage level that is higher than the switch-on voltage level of the charging station. As soon as this is detected, the charging station raises the voltage level from the switch-on voltage level to a charging voltage level. For this purpose, station comprises a voltage detection device (not shown).

1. A rail vehicle comprising:
an electrical energy storage device,
a charging contact device,
a charging control system with a charging control component,
a DC intermediate circuit, wherein the electrical energy storage device and the charging contact device are each connected to the DC intermediate circuit,
a charging switch is arranged between the charging contact device and the DC intermediate circuit, wherein the charging switch is controlled via the charging control component in such a way that
the charging switch is configured to be in a closed position only when a switch-on voltage level is detected by the charging control system and
the charging switch configured to achieve an electrical connection between the charging contact device and the DC link.

2. The rail vehicle according to claim 1, further comprising a communication means is designed for communication with the charging station.

3. The rail vehicle according to claim 1, further comprising a second charging contact devices.

4. The rail vehicle according to claim 1, wherein the charging switch is configured to be closed only by the charging control system.

5. The rail vehicle according to claim 1, wherein the charging contact device further comprises two poles.

6. A charging station for charging a rail vehicle comprising:
a charging station controller and a contact point for an electrical connection to a charging contact device of a rail vehicle, wherein the charging station controller is designed such that a switch-on voltage is applied to the charging contact device of the rail vehicle, that the switch-on voltage can be applied to the contact point and that the charging station controller recognizes when a higher battery voltage of the rail vehicle is present than the switch-on voltage of the charging station and a voltage level of the charging station can then be increased to a charging voltage.

7. The charging station according to claim 6, comprising a regulated rectifier and a power supply.

8. The charging station according to claim 7, wherein a line contactor with precharging contactor or a current limiting device is arranged between the contact point and the regulated rectifier.

9. A method for charging a rail vehicle with a charging station comprising:
applying a switch-on voltage level to a contact point of the charging station;
establishing an electrically conductive connection between a charging contact device and the contact point while the switch-on voltage level is applied;
closing a charging switch so that a DC intermediate circuit of the rail vehicle is connected to the charging station, with the battery voltage level applied;
detecting an applied battery voltage level with the charging station, where the applied battery voltage level is higher than the switch-on voltage level of the charging station; and
increasing a voltage level of the charging station from the switch-on voltage level to a charging voltage level.

10. The method according to claim 9, wherein the switch-on voltage level is lower than a lower voltage range of an energy storage device.

11. The method according to claim 9, comprising, first, detecting the rail vehicle using the charging station.

12. The method according to claim 9, wherein the rail vehicle communicates with the charging station via a communication means.

13. The method according to claim 9, comprising
terminating the charging process on the vehicle side.

14. The method according to claim 13, comprising:
informing the charging station via the communication means before the charging switch is opened that the charging process is to be terminated.

15. A charging system comprising a rail vehicle according to claim 1 and a charging station for charging a rail vehicle comprising a charging station controller and a contact point for an electrical connection to a charging contact device of a rail vehicle, wherein the charging station controller is designed such that a switch-on voltage is applied to the charging contact device of the rail vehicle, that the switch-on voltage can be applied to the contact point and that the charging station controller recognizes when a higher battery voltage of the rail vehicle is present than the switch-on voltage of the charging station and the voltage level of the charging station can then be increased to the charging voltage.

16. The method of claim 10 wherein the switch-on voltage level is lower than 400 volts.

17. The method according to claim 13 where the component of the rail vehicle is the charging switch.

18. The method of claim 9 comprising terminating the charging process by interrupting the contact between the charging contact device and the contact point.

19. The method of claim 14 comprising:
lowering the voltage level of the charging station; and
opening the line contactor with the charging station.

20. The method of claim 12 wherein the rail vehicle communicates a charging current or a charging voltage to the charging station.
